(19) United States
(12) Patent Application Publication
(10) Pub. No.: US 2016/0212949 A1
(43) Pub. Date: Jul. 28, 2016

(54) METHOD AND APPARATUS FOR COVERING ROWS OF HARVESTED SUN-SENSITIVE PRODUCE WITH RE-USABLE SHADING MATERIAL AND FOR RETRIEVING THE SHADING MATERIAL

(71) Applicant: Volm Companies, Inc., Antigo, WI (US)

(72) Inventors: Corbett Hefner, Antigo, WI (US); Martin Greenbank, Kanab, UT (US)

(73) Assignee: Volm Companies, Inc.

(21) Appl. No.: 14/602,684

(22) Filed: Jan. 22, 2015

(51) Int. Cl. A01G 13/00

(52) U.S. Cl. CPC A01G 13/025

(57) ABSTRACT

A machine and method are provided for laying down an air permeable shading material over a row of harvested produce items and of subsequently retrieving the shading material in a manner that permits its reapplication over another row of produce items. The machine includes a frame, wheels supporting the frame on the ground, and a roll support that supports a roll of a shading material. The machine additionally includes a reversible motor that imparts a rotational driving force to the roll support. The machine is configured and controlled to loosely lay shading material over a row or to wind shading material back onto the roll in a manner that inhibits side-to-side movement of the material relative to the frame and that inhibits material wrinkling.

### BACKGROUND OF THE INVENTION

1. Field of the Invention

The invention generally relates to machines for laying an aeration and shading material on a row of harvested produce items. More particularly, the invention relates to a machine that can unwind shading material from a roll, cover a row of harvested produce items with the material, and subsequently rewind the material in manner that permits reapplication of the shading material. The invention additionally relates to a method of using such a machine.

2. Discussion of the Related Art

Certain produce, mostly notably certain varieties of onions, must be “cured” by being exposed to the air before significant handling to prevent them from being bruised, damaged and inhibit pathogens from invading the bulb and causing decay. However, many varieties of onions and other produce also are extremely sensitive to the sun upon being harvested. White onions, for example, may begin to burn within one hour of being exposed to the sun. Hence, it is necessary to expose such produce items to the air immediately upon harvesting while keeping them out of the sun before significant handling such as transportation and bagging.

Presently, the harvesting of white onions is an extremely labor-intensive process, often requiring the use of dozens or even hundreds of laborers in a field. First, the rows of onions are undercut to permit easy removal. They are then dug-up, either manually or using a harvesting machine. They may also be “green-chopped” or “topped” by hand or a machine to remove the upper stalk and root mass from the onion. The onions are then placed in burlap bags. The onions thus are protected from the sun but are exposed to curing air. They are left in this manner for approximately five to fourteen days. The onions can then be manually or mechanically removed from the burlap bags and bagged or otherwise packaged for transport.

Some produce items that do not require curing are simply harvested and “windrowed” or placed in rows before being picked up and transported and/or packaged. However, some varieties of onions could not heretofore be windrowed, at least upon initial harvesting, without undesirably exposing them to the sun and mechanical damage prior to curing enough to facilitate mechanical harvesting or other handling.

In addition, various machines and methods are known for applying strips of film or other sheet material to the ground for a variety of purposes, but most such machines require that that the material be retrieved either manually or by a machine that bunches the material or otherwise renders it unsuitable to be reused. The resulting waste of the material substantially increases the costs of many agricultural operations and undesirably leads to their carbon footprints, both through the need to produce additional sheet material and through the need to dispose of the spent sheet material.

The need therefore exists to provide a method and apparatus that permits increased automation of the harvesting of onions and other harvested produce items that are sensitive to the sun and pathogens.

The need also has arisen to provide a method and apparatus for covering rows of onions or other sun-sensitive produce items with a shading material and to retrieve the shading material in a manner that permits its reuse.

### SUMMARY OF THE INVENTION

In accordance with a first aspect of the invention, a machine is capable of laying down shading material over a row of harvested produce items and of subsequently retrieving the shading material in a manner that permits its reapplication over another row of harvested produce items. The machine includes a frame having front and rear ends, wheels supporting the frame on the ground, and a roll support, mounted on the frame in the vicinity of the rear end thereof, that supports a roll of a shading material. The machine additionally includes a reversible motor that imparts a rotational driving force to the roll support, and guides that 1) guide shading material being unwound from the roll over a row of harvested produce items as the machine traverses over the row and 2) guide shading material being rewound back onto the roll so as to inhibit side-to-side movement of the material relative to the frame and to inhibit material wrinkling.

The guides may include one or both of a 1) guide rollers that direct shading material between the roll and the row and 2) a bowed rod or other device that engages shading material moving therepast so as to inhibit wrinkling of the shading material.

The machine may additionally include an edge covering assembly that covers opposed edges of the shading material with soil after the shading material is laid down over the row to hold the shading material in place over the row.

In accordance with another aspect of the invention, a method is provided of laying down and retrieving shading material. The method includes, as a mobile frame is towed over a harvested row of produce items, unwinding a shading material from a roll with a support being mounted on the frame. Then, as the frame is directed over the row, laying the withdrawn shading material onto the row while at least substantially preventing wrinkling of the shading material or side-to-side motion of the shading material relative to the frame. Another step includes, as the frame is directed over the row, rewinding the shading material onto the roll while at least substantially preventing wrinkling of the shading material or side-to-side motion of the shading material relative to the frame.

The machine may lightly tension shading material being laid down so as minimize contact between the material and the underlying produce items. It may also help shed debris from shading material being retrieved.

The shading material may be an air permeable material such as an open mesh material.

The winding and unwinding steps may be performed with the aid of a reversible motor that imparts a drive torque to the roll. The motor speed may be adjusted in dependence on the diameter of the roll of shading material. The unwind speed of the material may be controlled to essentially equal the ground speed of the machine.

While laying down the shading material, the machine may cover the opposed edges of the shading material with soil to hold the shading material in place. The machine may also dig furrows into which the opposed edges of the shading material are pressed prior to covering them with soil.

Various other features, embodiments and alternatives of the present invention will be made apparent from the following detailed description taken together with the drawings. It should be understood, however, that the detailed description and specific examples, while indicating preferred embodiments of the invention, are given by way of illustration and not limitation. Many changes and modifications could be made within the scope of the present invention without departing from the spirit thereof, and the invention includes all such modifications.

### BRIEF DESCRIPTION OF THE DRAWINGS

Exemplary embodiments of the invention are illustrated in the accompanying drawings, in which like reference numerals represent like parts throughout, and in which:

FIG. 1 is an isometric view of a shading material application and retrieval machine constructed in accordance with the invention, viewed from above, in front of, and the left side of the machine;

FIG. 2 is a left-side elevation view of the machine of FIG. 1;

FIG. 3 is a front elevation view of the machine of FIG. 1;

FIG. 4 is a rear elevation view of the machine of FIG. 1;

FIG. 5 is a bottom plan view of the machine of FIG. 1;

FIG. 6 is an isometric view of the machine of FIG. 1, viewed from behind, beneath, and the left side of the machine;

FIG. 7 is a top plan view of the machine of FIG. 1;

FIG. 8 is a sectional elevation view taken generally along the lines 8-8 in FIG. 7;

FIG. 9 is a sectional elevation view taken generally along the lines 9-9 in FIG. 7;

FIG. 10 is a perspective sectional view of the machine of FIG. 1, showing shading material being unwound from a roll;

FIG. 11 is a sectional side elevation view of the machine of FIG. 1, being towed by a tractor and laying down a shading material over a row of harvested produce items;

FIG. 12 is an isometric view of the machine of FIG. 1, viewed from in front of the machine and showing the laying down of shading material over a row of harvested produce items;

FIG. 13 is a fragmentary isometric view of a portion of the machine of FIG. 1 and showing the laying down of shading material over a row of harvested produce items;

FIG. 14 is an isometric view of the machine of FIG. 1, viewed from behind the machine and showing the application of a shading material over a row of harvested produce items;

FIG. 15 is a side elevation view of the machine of FIG. 1 and showing the machine retrieving shading material from a row of harvested produce items;

FIG. 16 is an enlarged fragmentary view of the portion of the machine shown in the area designated “16” in FIG. 15;

FIG. 17 is a fragmentary isometric view of a portion of the machine of FIG. 1 and showing the retrieval of shading material from a row of harvested produce items;

FIG. 18 is an enlarged fragmentary isometric of a portion of the machine of FIG. 1 including one of the hillers of the machine;

FIG. 19 corresponds to FIG. 18 and shows the manner in which the hiller of FIG. 18 can be moved vertically and horizontally relative to the frame;

FIG. 20 is an exploded isometric review of the portion of the machine shown in FIG. 18; and

FIG. 21 is a sectional plan view taken generally alone the lines 21-21 in FIG. 18.

### DETAILED DESCRIPTION OF SPECIFIC EMBODIMENTS

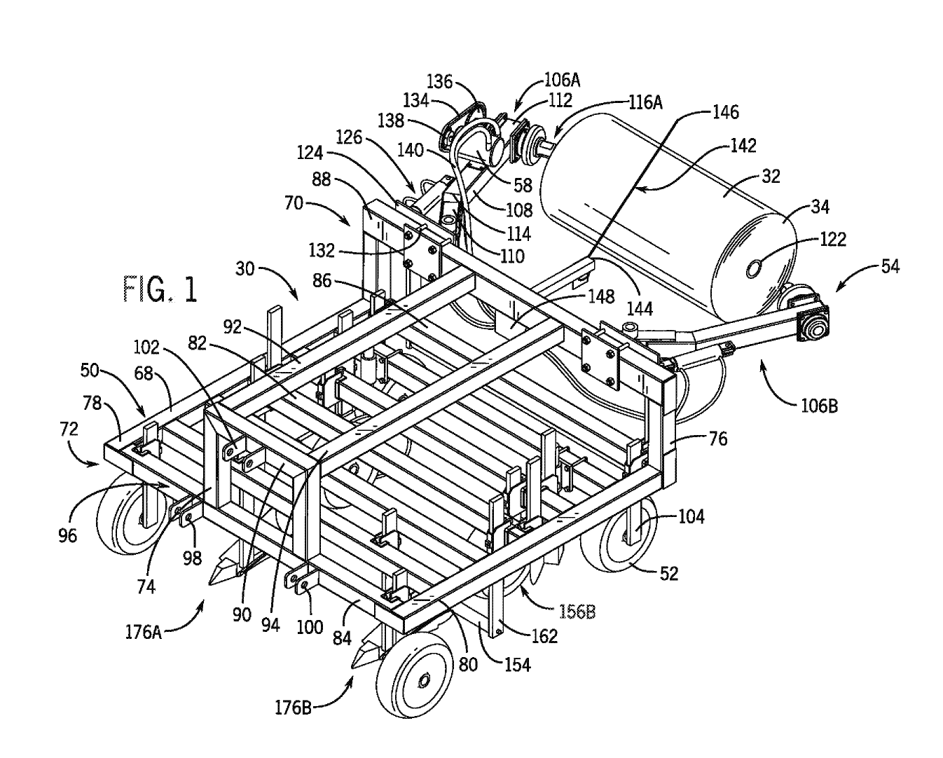

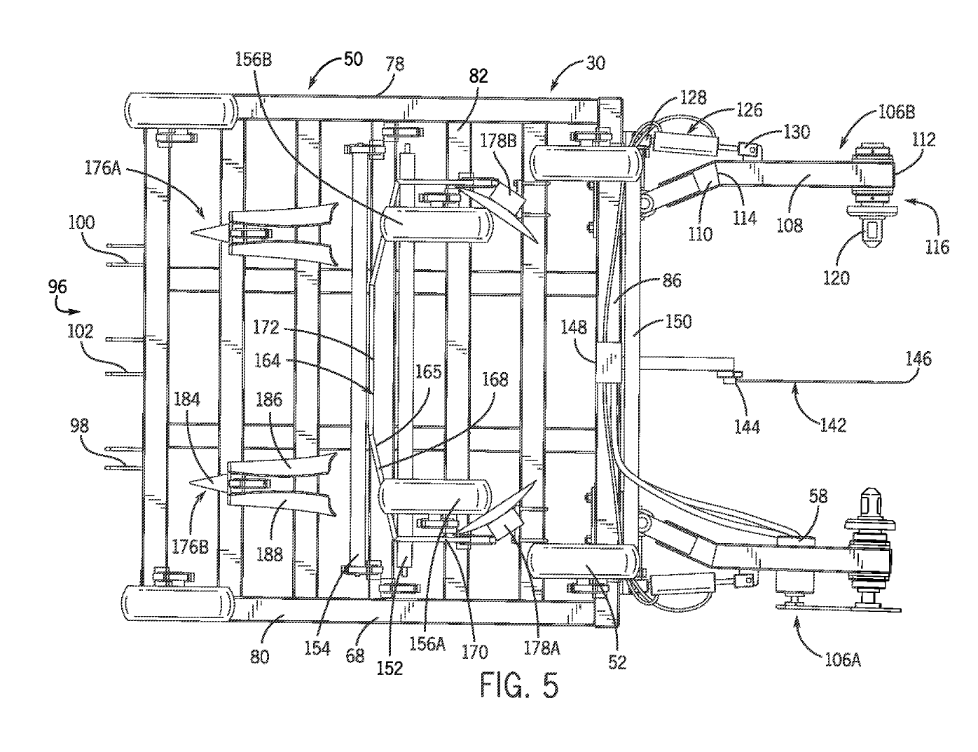

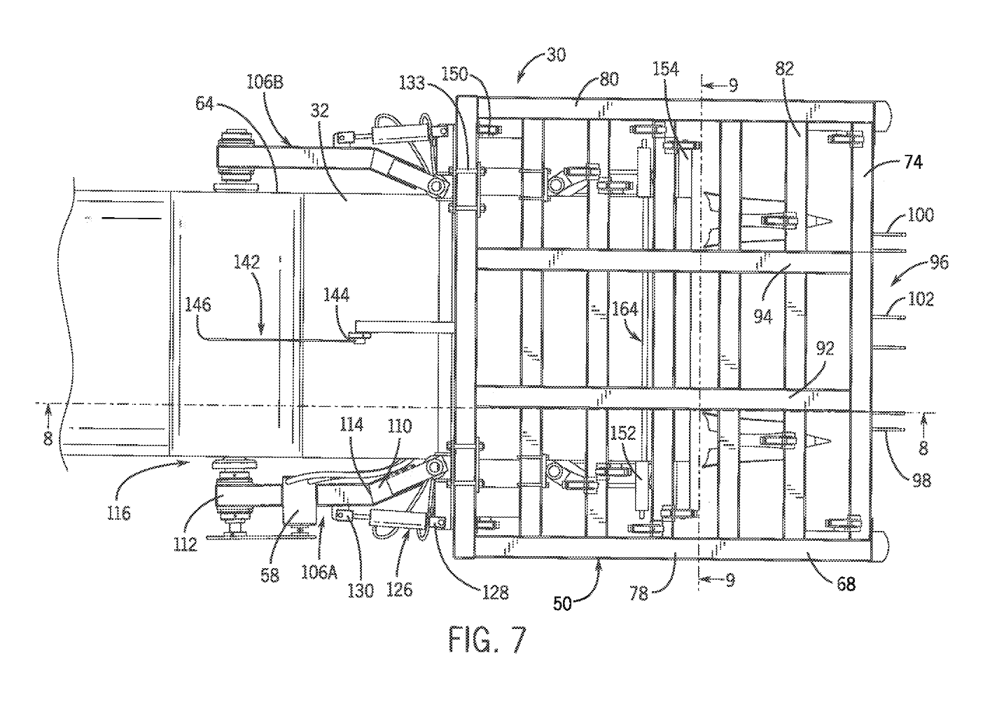

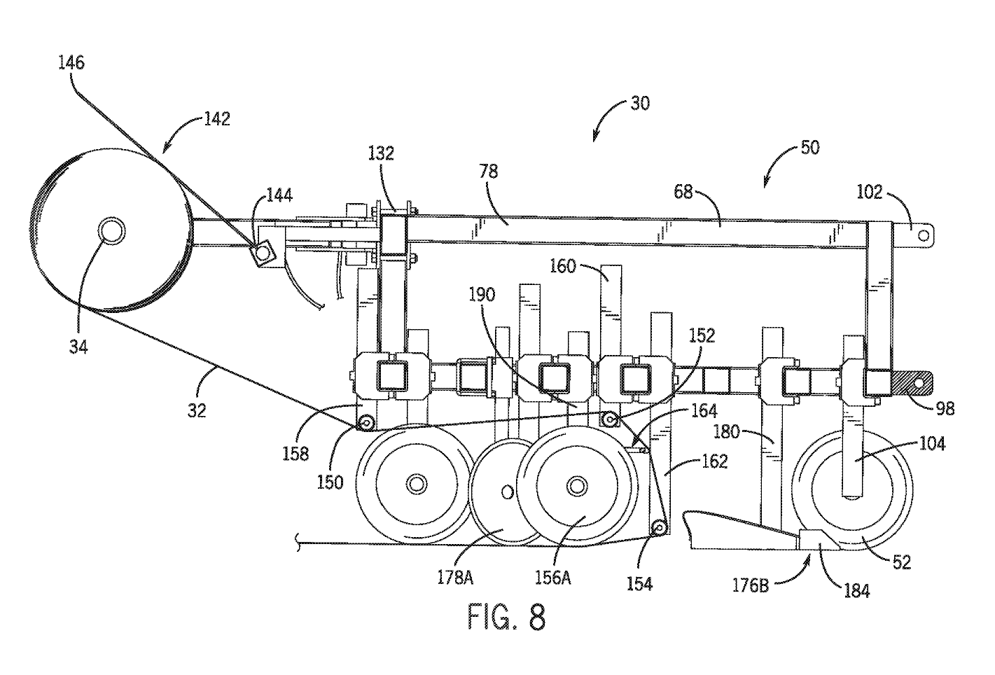

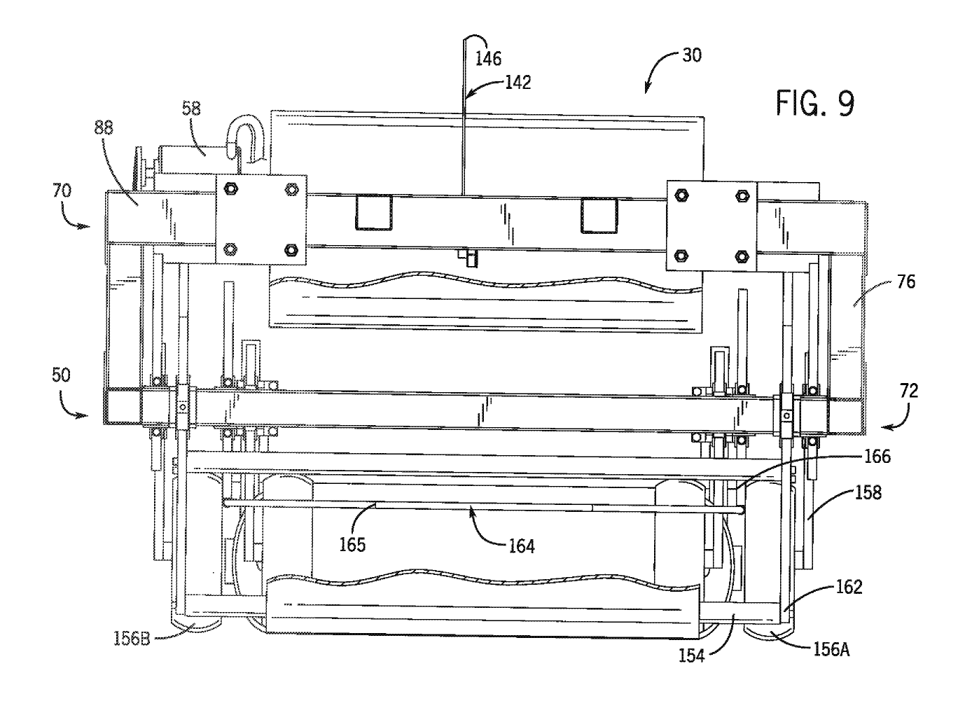

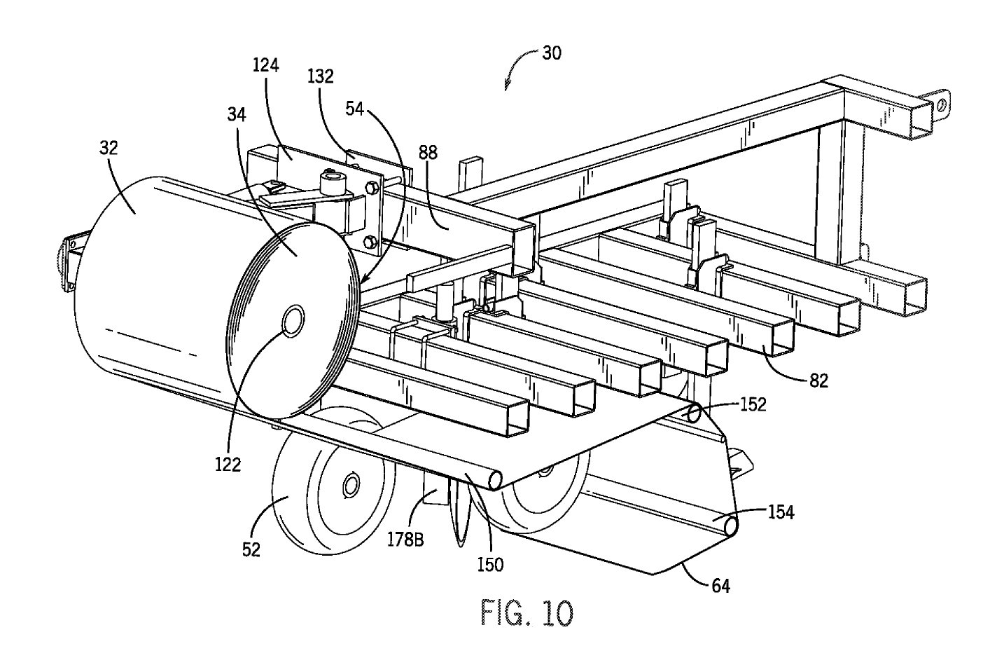

Referring generally to the drawings, a machine 30 is illustrated that is capable of removing a continuous sheet of shading material 32 from a roll 34 and laying it down over a row 37 of sun-sensitive and pathogen-sensitive harvested produce items 36 such as white onions. The machine 30 also is capable of retrieving that shading material 32 and rewinding it onto a roll 34 for reapplication over another row of harvested produce items. Referring particularly to FIGS. 1-9, the machine 30 includes a frame 50, a roll support assembly 54 that receives drive torque from a reversible hydraulic motor 58, a system of guides 60, and an edge covering system 62. The guides 60 direct shading material being unrolled from the roll 34 over a row 37 while inhibiting side-to-side movement of the shading material 32 relative to the frame 50 and inhibiting material 32 wrinkling. The guides 60 also guide shading material 32 being rewound back onto the roll 34 so as to inhibit side-to-side movement of the shading material 32 relative to the frame 50 and to inhibit material 32 wrinkling. The edge covering system 62 covers the opposed edges 64 of the strip of shading material 32 with soil to hold the shading material 32 in place over the row.

The frame 50 of this embodiment includes a weldment formed by a number of tubular rectangular steel beams 68 welded or otherwise affixed to one another. The length and width of the frame 50 may vary significantly from application-to-application so long as the frame 50 is sufficiently long to support the above-mentioned components and sufficiently wide to support a roll 34 of a maximum desired width and to lay shading material unwound from that roll 34 down over a row of harvested produce items. That width is six to twelve feet in the illustrated embodiment, and more typically, of about seven feet. The length may vary from five to ten feet in the presently illustrated embodiment, and is more typically of about eight feet.

The frame 50 includes upper and lower portions 70, 72 connected to each other via front and rear vertical support tubes 74, 76. The lower portion 72 includes first and second longitudinally extending beams 78, 80 and a plurality (seven in this embodiment) of transverse cross beams 82 having opposed ends connected to the respective longitudinal beams 78, 80. These cross beams 82 include front and rear cross beams 84, 86 and five evenly-spaced intermediate cross beams 82. The upper portion 70 of the frame 50 includes a rear cross beam 88 extending the full width of the machine 30, a front cross beam 90 of shorter width centered over the machine 30, and first and second longitudinal beams 92, 94 connecting the upper end of the front cross beam 90 to the central portion of the rear cross beam 88. Attachment points for a three-point hitch mechanism 96 are mounted on the front of the frame 50. These attachment points include first and second spaced lower attachment points 98, 100 extending forwardly from the front face of the lower front cross beam 84, and a third attachment point 102 extending forwardly from the center of the front face of the upper front cross beam 90. The frame 50 is supported on the ground via four support wheels 52 located in the vicinity of respective corners of the frame 50. Each wheel 52 is mounted to the frame 50 by a post 104 that is vertically movable relative to the frame 50 to adjust the height of the frame 50 relative to the ground.

Referring now to FIGS. 1, 2, 4, and 6, the roll support assembly 54 is configured to removably engage a roll 34 of shading material 32 and to accommodate rotation of the roll 34 on that support assembly 54 so as to permit material winding and unwinding. It also may be configured to accommodate shading material rolls of different widths. In the illustrated embodiment, the roll support assembly 54 comprises two spaced arms 106A and 106B mounted on the upper portion 70 of the frame 50 and extending rearwardly therefrom. The arms 106A and 106B are of identical construction and are mirror images of each other. Arm 106A therefore will be described, it being understood that the description applies equally to the arm 106B. The arm 106A includes a beam 108 having a front end 110 attached to the frame 50, a rear end 112, and an elbow 114 between the front and rear ends 110 and 112. The rear end 112 supports an expandable core chuck 116. As is known in the art, the core chuck 116 includes an expandable sleeve 120 mounted over a tapered shaft (not shown) so as to expand or contract with movement along the shaft 120, thus accommodating roll cores 122 of varying diameters Alternatively, the core chucks 116 may be conical to accommodate roll cores 122 of different widths and to facilitate centering of a roll 34 on the frame 50. The front end 110 of the arm 106A is pivotally mounted to a plate 124 located behind the rear face of the rear cross beam 88 of the upper frame portion 70. A hydraulic cylinder 126 is disposed outboard of the beam 108 for driving the arm 106A to pivot. The hydraulic cylinder 126 has a front end 128 attached to the plate 124 and a rear end 130 attached to the arm 106A rearwardly of the elbow 114. Extension and retraction of the hydraulic cylinder 126 causes the rear end 112 of the arm 106A to swing inwardly or outwardly relative to the center of the frame 50 to engage or disengage a roll 34 of shading material 32. The arm 106A is movable transversely of the machine 30 to accommodate rolls 34 of varying widths by attaching the plate 124 to the rear cross beam 88 via a clamp assembly 132 that can be selectively loosened to move the plate 124 transversely along the beam 88. Additional support for the arm 106A could be provided by a vertical support post 158 and a second clamp assembly 133 attached to the lower rear cross beam 86.

Alternatively, the arms 106A and 106B could be linear rather than inclined, and/or each arm 106A and 106B could be driven to move linearly transversely relative to the frame 50 to selectively engage a roll 34.

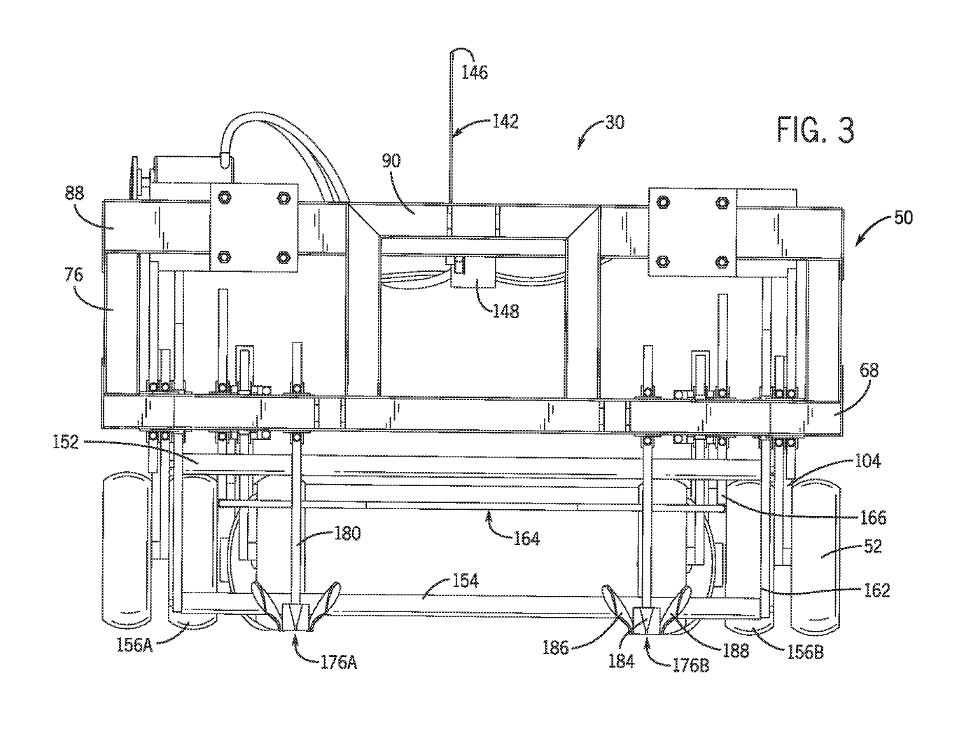

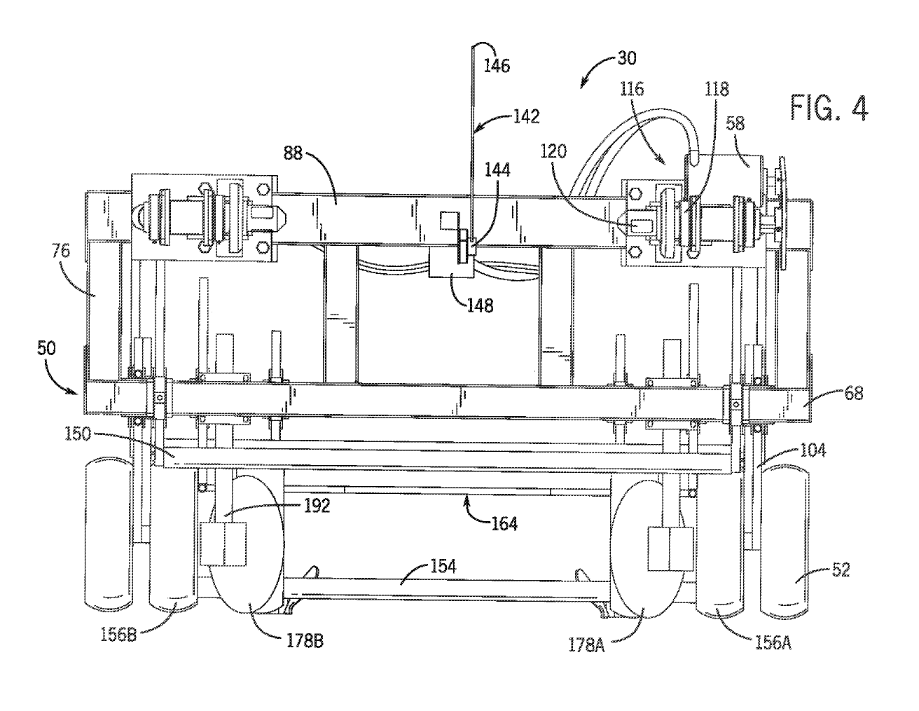

At least one of the core chucks 116 receives drive torque from a reversible hydraulic motor 58, best seen in FIGS. 1-4. In the illustrated embodiment, the right chuck 116 is connected to an output of the motor 58 via a chain 134 and drive 138 and driven sprockets 136 provided on the motor 58 and the driveshaft of the core chuck 116, respectively. The motor 58 is supplied with hydraulic fluid via a proportional control valve assembly 148, shown schematically in FIGS. 3 and 4. Hydraulic fluid is supplied from a tractor (not shown) or other prime mover via hoses 120. The speed of the motor 58 can be adjusted via operation of the control valve assembly 148. In one embodiment, a threshold motor speed is set in dependence upon the speed that the machine travels across the ground or the “ground speed” of the machine 30 and is adjusted depending upon the diameter of the roll 34 of shading material 32. In this manner, the linear speed of material 32 being wound onto or off from the roll 34 can be maintained constant despite changes in roll rotational speed occurring as a result of changes in roll diameter. That speed preferably is set to be equal to the groundspeed of the machine 30, permitting unwinding of the shading material 32 under relatively low tension without excessive slack so that it is relatively loosely draped over the produce row and maintaining a generally semi-circular transverse cross section rather than being stretched against it and conforming to the “lumpy” profile of the produce items, thus reducing the number of contact points with the underlying onions and improving both shading and ventilation. The speed preferably is set to unwind the material 32 at a tension of less than 2.0 pounds per linear inch (LPI) and preferably less than 1.0. Roll diameter is monitored by a sensing arm 142. The sensing arm 142 has a front end 144 pivotally attached to the control valve assembly 148 and a rear end 146 that rests freely on the roll 34. Pivoting movement of the sensing arm 142 adjusts the control valve assembly 148 to vary motor speed. In a more sophisticated embodiment, the sensing arm 142 or another sensor, such as an optical sensor, could sense roll diameter and generate a signal that is transmitted to a controller that, in turn could adjust the control valve assembly 148. The threshold speed may be set manually to match the ground speed of the machine. That ground speed may be assumed based on operator parameters or, more preferably, may be monitored based on signals from a speedometer, a GPS, or the like.

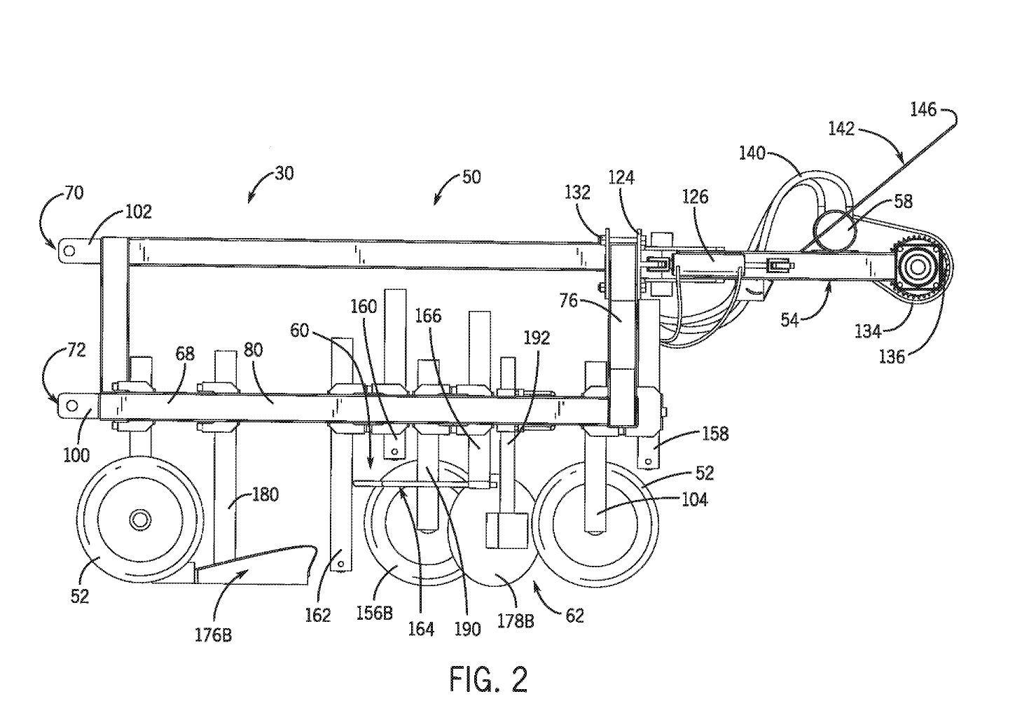

Referring now to FIGS. 2, 5, 6, and 8, the guides 60 of this embodiment include a series of idler rollers 150, 152, 154 and a bowed rod 164. Three idler rollers are provided in the illustrated embodiment. The first idler roller 150 is located just rearwardly of idler wheels 156A, 156B, described below, and just below the bottom of the lower portion 72 of the frame 50 immediately behind the wheels. Its ends are rotatably supported on support plates 158 mounted on opposed ends of the rear face of the rear cross beam 86. The second idler roller 152 is located just forward of the idler wheels 156A, 156B and slightly above the first idler roller 150. Its ends are rotatably mounted on respective support posts 160 extending downwardly from the rear surface of one of the intermediate transverse cross beams 82. The third idler roller 154 is located in front of the idler wheels 156A, 1568 and substantially below the second idler roller 152. Its ends are supported on the frame 50 by respective support posts 162 that extend downwardly from the front surface of the same cross beam 82 on which the support posts 160 for the second idler roller 152 are mounted. In use, shading material 32 passes under the first idler roller 150, over the second idler roller 152, and part way around the third idler roller 154 as it is being applied or retrieved so as to be directed into engagement with the ground in front of the idler wheels 156A, 156B during an application process or to be directed onto a roll during a retrieval process.

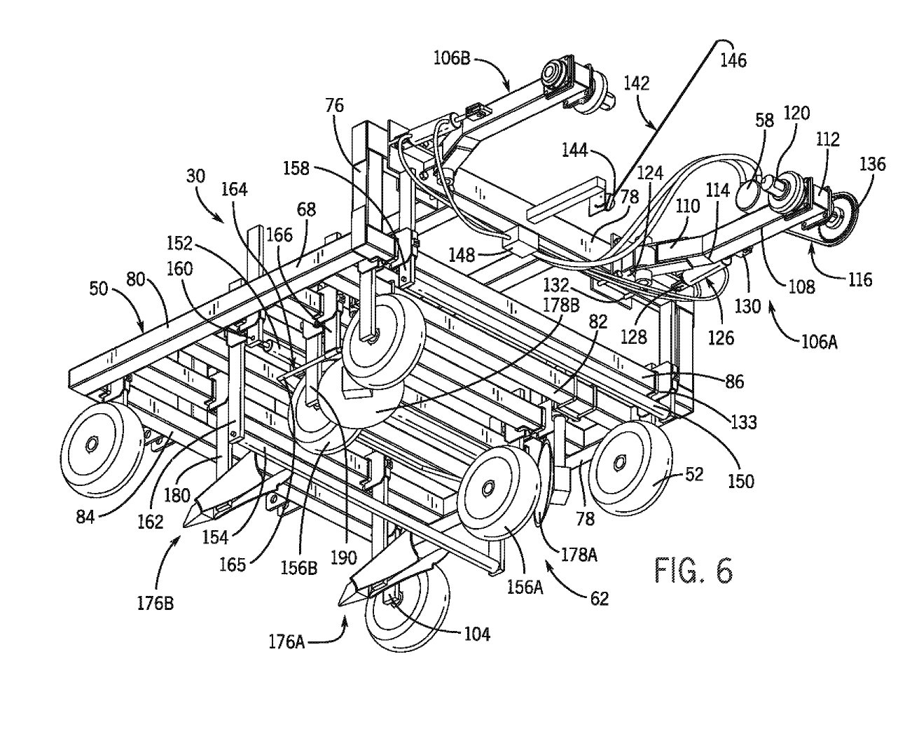

Still referring FIGS. 2, 5, 6, and 8, additional shading material 32 guidance is provided by the bowed rod 164, which takes the form of a horizontal bowed bar located between the second and third idler rollers 152, 154 in the direction of shading material 32 travel. This bar 164, like the idler rollers 150, 152, 154, helps keep the shading material 32 under light tension, thus avoiding wrinkling. It also is bowed so as to inhibit side-to-side movement or wandering of shading material 32 being withdrawn from or wound onto the roll 34. The bowed bar 164 is formed from a bent solid metal circular rod 165. It has first and second ends 170 extending horizontally forwardly from first and second transversely spaced supports 166 that extend downwardly from the lower frame portion 72 near the rear end of the idler wheels 156A, 156B as best seen in FIG. 6. The bowed bar 164 also has first and second inclined portions 168 that extend forwardly and inwardly from the first and second ends 170 toward the center of the machine 30. A linear or, possibly, slightly curved center portion 172 connects the inner ends of the first and second inclined portions 168, thus completing the “bowed” shape of the bar 164. The bowed rod could be replaced by a roller or other structure providing the desired functionality.

In addition to guiding the shading material 32 during both application and retrieval operations, the bowed bar 164 helps the material to shed debris 1042 during a retrieval operation as will be detailed below.

The edge covering assembly 62 includes hillers 176A and 176B, idler wheels 156A and 156B, and closing disks 178A and 178B that cooperate with one another to cover opposed edges 64 of the shading material 32 with soil 66 after the shading material 32 is laid down over a row 37 of harvested produce items 36 and holds the shading material 32 in place over the row 37. Two of each of these devices are mounted on opposite sides of the machine 30 as mirror images of one another. They are spaced equally from the center of the machine 30 so as to be in general alignment with the respective edges 64 of shading material 32 being laid down over the row 37 or retrieved from the row 37. Only one of each of these devices will now be detailed for the sake of brevity, it being understood that the description applies equally to the corresponding device on the opposite side of the machine.

Referring now to FIGS. 2, 3, 5, and 6, the hiller 176B is mounted near the corner of the front cross beam 84 of the frame by a post 180 so as to be located inwardly and just rearwardly of the front support wheels 52. The hiller 176B operates as a plow that digs a furrow 182 of about one to three inches deep in the soil 66 and that piles soil 66 adjacent both sides of the furrow 182. The hiller 176B thus includes a front knife 184 that digs into the ground to form the furrow 182 and first and second curved guides 186, 188 that extend upwardly and rearwardly from the knife 184 to direct soil 66 excavated from the furrow 182 alongside the furrow 182. Inner guide 186 also acts as a shield to keep the produce from being damaged or crushed by the idler wheels 156A, 156B.

Referring now to FIGS. 2, 5, and 6, the idler wheel 156B is mounted on a post 190 located longitudinally between the hiller 176B and the closing disk 178B and behind the bowed bar 164. It is located generally in line with and preferably just outboard of the center of the associated hiller 176B so as to roll along the edge 64 of the shading material 32 after the shading material 32 has been laid onto the row 37 with its edge 64 overlapping the furrow 182. The idler wheel 156B rotates about a horizontal axis extending transversely of the machine 30. It should be noted that the idler wheels 156A and 156 B could be replaced with non-rotating components, such as skis. Because they provide a larger contact area with the underlying material, skis more prove more effective than wheels at avoiding wrinkling of the material being laid down.

Referring now to FIGS. 2, 4, 5, and 6, the closing disk 178B is mounted on a post 192 that extends downwardly from the bottom of one of the transverse cross beams 82 of the frame 50 behind the associated idler wheel 156B. The closing disk 178B is supported on the bottom of the post 192 so as to rotate about a horizontal axis that extends at an angle of between 20° and 45° relative to the longitudinal. The center of the closing disk 178B may be located at or, more preferably, outboard of the center of the axis of the associated idler wheel 156B so that rotation of the closing disk 178B in contact with the ground throws soil 66 rearwardly and inwardly to cover the edge 64 of the recently applied shading material 32.

As mentioned above, the hillers 176, closing disk 178, and idler wheels 156 are all mounted on the frame 50 so as to be movable transversely thereof to accommodate rolls 34 of varying widths. They also are movable vertically relative to the frame 50 1) to accommodate different frame heights as determined by the locations of the support wheels 52 relative to the frame 50 and 2) to move to a raised, inoperative or stowed position during a shading material retrieval operation. The same or similar mounting arrangement can be used for each of these devices to obtain the desired capability. Hence, while one such mounting arrangement will now be described with respect to one of the hillers 176B, it is to be understood that the same or similar mounting arrangements can be used with respect to the other hiller 176A, both idler wheels 156A and 156B, and both closing disks 178A and 178B.

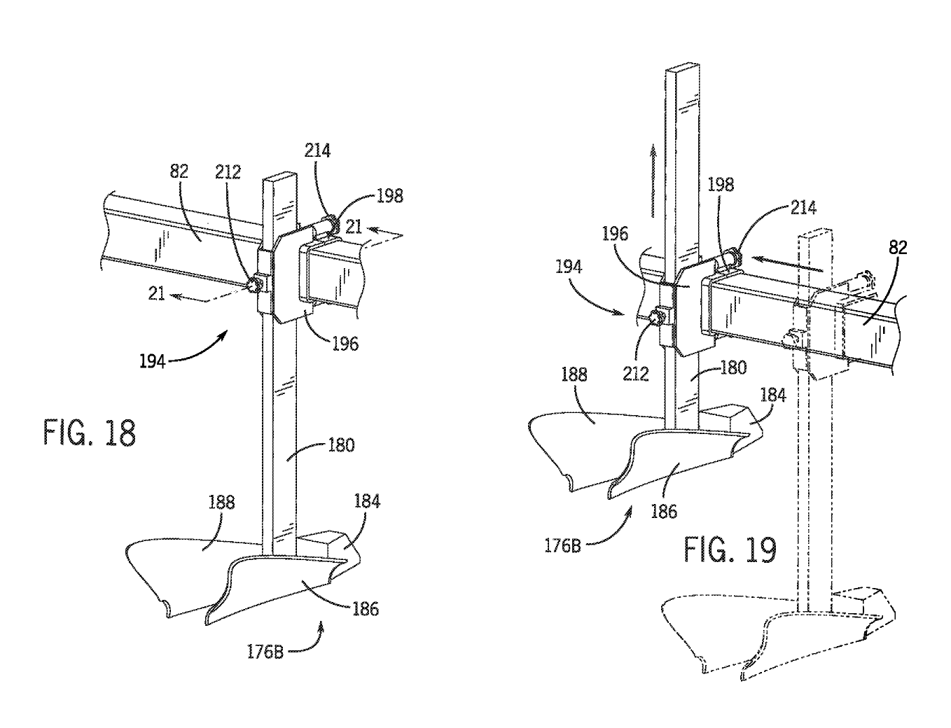

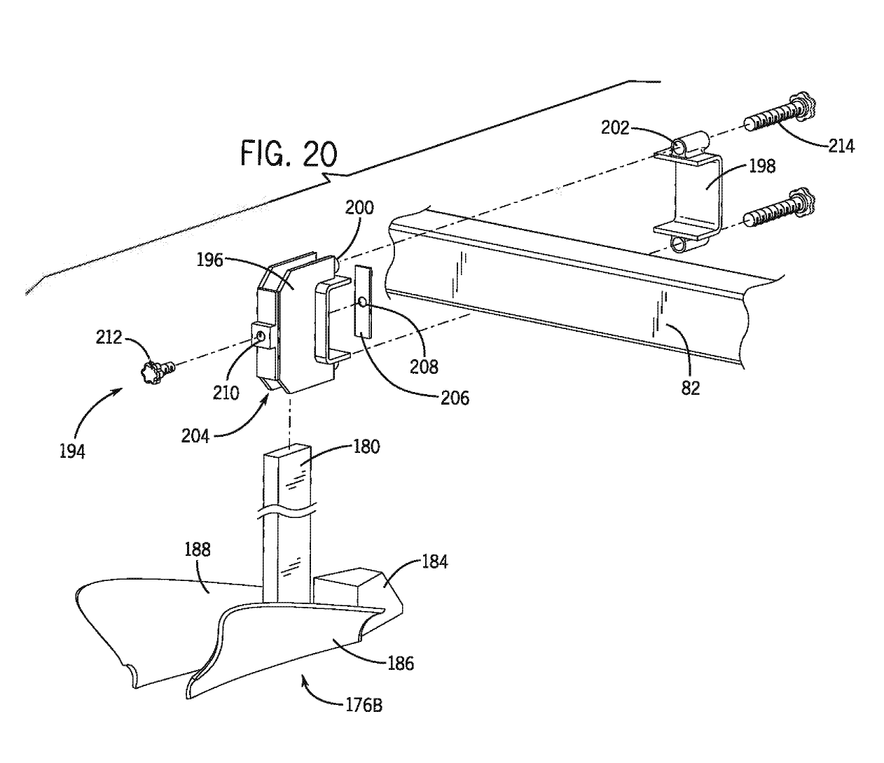

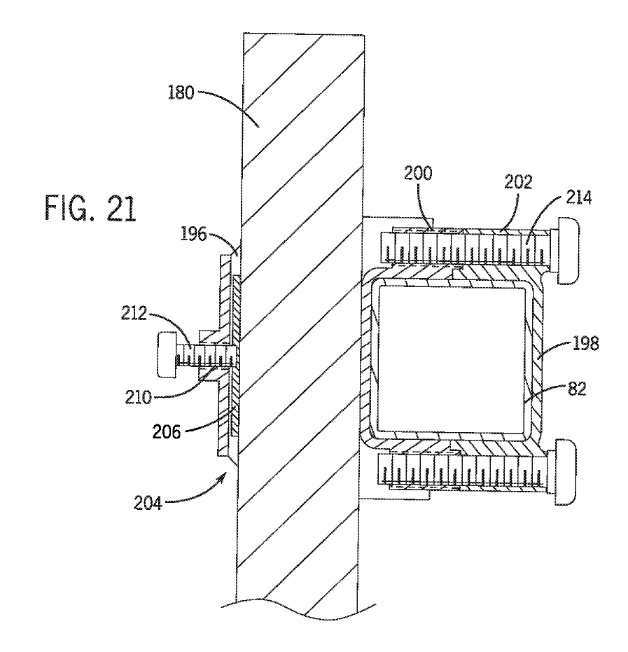

Referring now to FIGS. 18-21, the support post 180 for the hiller 176B is mounted on the transverse cross beam 82 by a clamp assembly 194. The clamp assembly 194 includes first and second mating jaws 196, 198 disposed outwardly of respective front and rear faces of one of the cross beams 82. Each jaw 196, 198 is generally c-shaped so as to be engageable with a respective surface of the cross beam 82. Threaded receptacles 200 are mounted on opposed sides of the jaw 196 for selective alignment with bolt receptacles 202 on opposed sides of the mounting jaw 198. A sleeve 204 is formed integrally with the outer portion of the first mounting jaw 196 to define a passage through which the support post 180 for the hiller 176B is vertically movable. A clamp plate 206 with a recess 208 is provided between the support post 180 and an outer surface of the passage. The outer surface of the first mounting jaw 196 has a threaded through bore 210 aligned with the recess 208 in the clamp plate 206. As best seen in FIG. 21, a threaded bolt 212 is threadable through the through bore 210 and into engagement with the recess 208 in the clamp plate 206 to clamp the post 180 between the cross beam 82 and the inner surface of the first mounting jaw 196 to hold the post 180 in a desired vertical position relative to the cross beam 82.

Referring now to FIG. 19, to adjust the position of the hiller 176B vertically relative to the frame 50 such as movement between the position shown in phantom lines to the position shown in solid lines in that drawing, one only need to loosen the bolt 212 to relieve tension from the clamp plate 206, raise the post 180 to the desired position, and re-tighten the bolt 212. To move the hiller 176B longitudinally from the position shown in the phantom lines and the position shown in the solid lines, one only need to loosen the first and second bolts 214 connecting the two jaws 196, 198 together sufficiently to un-clamp the jaws 196, 198 from the transverse cross beam 82, move the clamp assembly 194 in the direction indicated by the horizontal arrow, and re-tighten the first and second bolts 214.

Of course, one of any number of clamp assemblies could be used in place of the illustrated clamp assembly 194, so long as the selected clamp assembly permits vertical and horizontal adjustment of the position of the associated device.

Operation of the shading material application and retrieval machine 30 as thus far described will now be detailed.

First, to prepare the machine 30 for application, onions or another sun sensitive crop are harvested, de-topped and de-rooted if desired, and combined in a row 37 commonly referred to as a “windrow.” These tasks could be performed manually, via a digger or an excavation machine or other harvester (not shown), or a combination of both. In the case of white onions, which typically are planted in beds each having four to six rows spaced about four inches apart, four or more beds may be combined into a single windrow, creating a pile of harvested onions eight inches to as high as one foot or even higher. A machine suitable for this purpose is manufactured by Top Air of Parma, Id. That machine utilizes air and a sickle knife to efficiently sever the tops from the onions. The onion tops, along with other light debris, are then ejected out the rear of the machine. A lowering conveyor system then transfers the clean onions to the ground into windrows.

It should be noted, however, that harvesting need not entail this degree of handling. For example, onions or other bulb or root-type produce items could simply be undercut with a bar or other device that disturbs the soil sufficiently to render the produce items only partially excavated, if at all. So long as the produce items are sufficiently disturbed to significantly hamper or destroy their biological viability and to be relatively easily retrieved, the produce items can be considered “harvested.”

To prepare the machine 30 for operation, the wheel mounting posts 104 are adjusted vertically to adjust the height of the frame 50 to accommodate the prevailing windrow height. The frame 50 should be at a height at which the third idler roller 154 is high enough to clear the top of the windrow but not so high that the shading material 32 “flutters” as it is being laid down. The lateral positions of the roll support arms 106A and 106B, hillers 176A and 176B, idler wheels 156A and 156B, and closing disks 178A and 178B are set to match the desired width of the roll 34 of shading material 32. That width could be from about three feet to about six feet in the present embodiment. Greater widths could be accommodated if the machine 30 were to be scaled up. A roll of shading material 32 is then positioned between the outstretched arms 106A and 106B, and the hydraulic cylinders 126 are actuated to engage the core 122 of the roll 34 with the core chucks 116.

The preferred shading material 32 will depend on the nature of the harvested produce items 36 being covered. It should at least inhibit the transmission of UV rays that cause sunburn. It also should be sufficiently air permeable to permit air to flow through the material and dry the onions sufficiently to prevent pathogens from invading the produce items and causing decay. Hence, in the case of white onions, the preferred material is sufficiently opaque to act as a shade yet is air permeable. It preferably is an open-mesh material. One acceptable shading material is a knit fabric shade cloth manufactured by Plaspack, USA, a subsidiary Volm Companies, Inc.®.

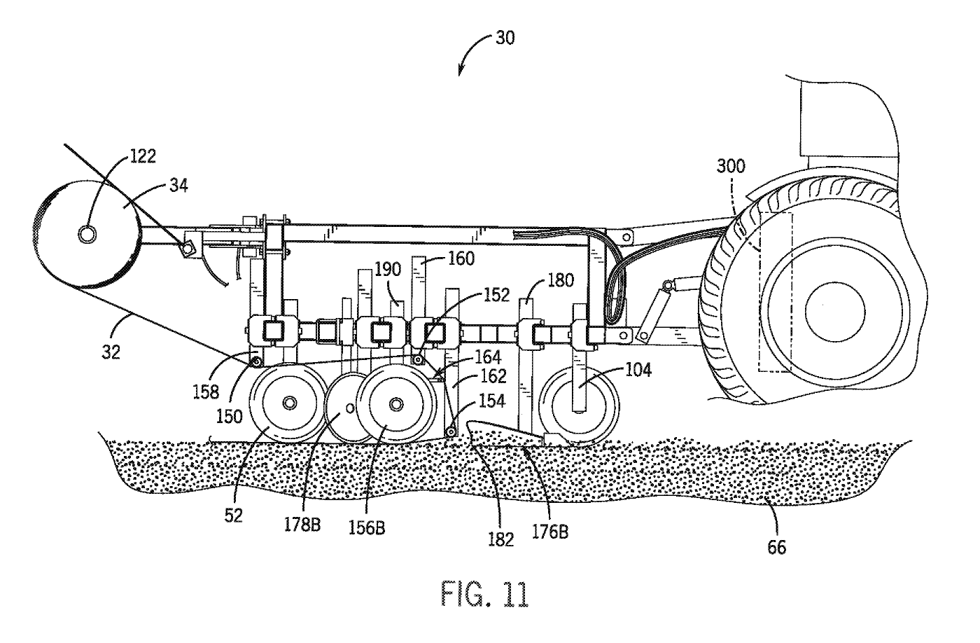

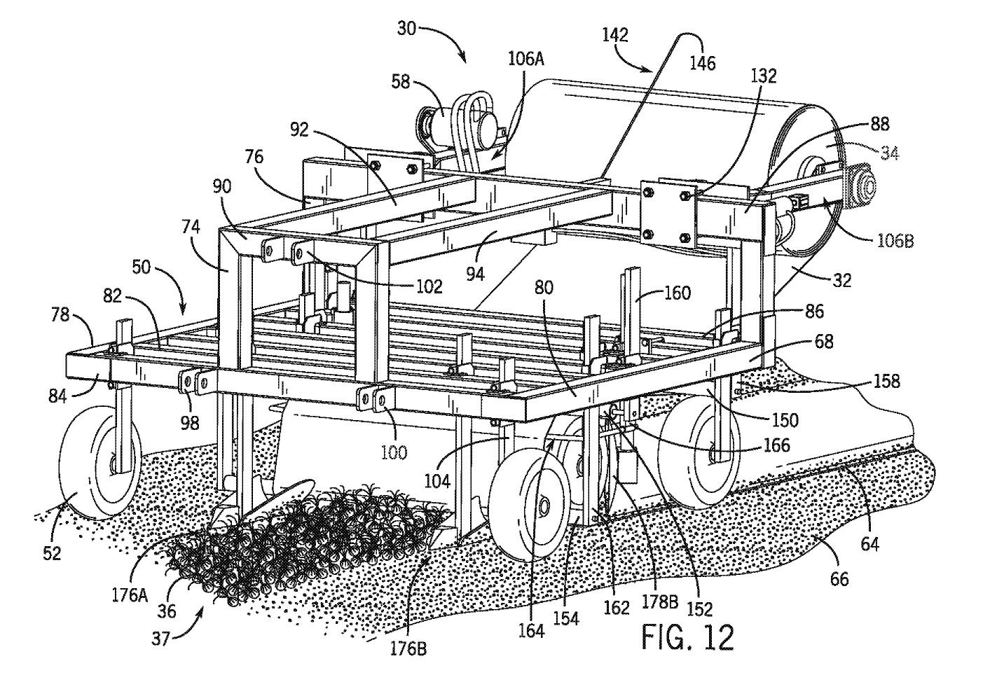

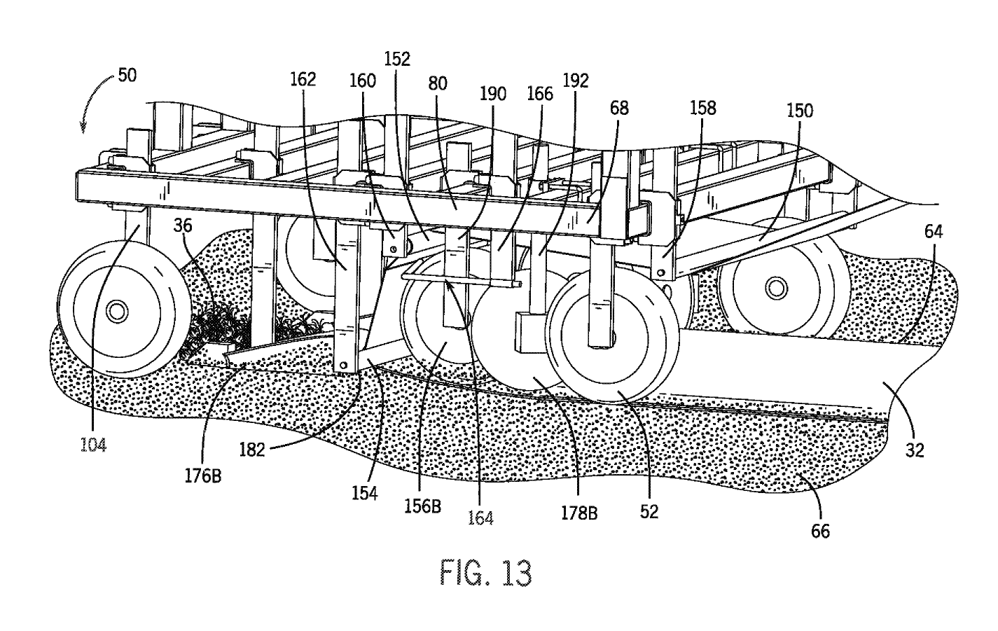

The machine also is connected to the three-point hitch mechanism 96 of a tractor or other prime mover at this time as best seen in FIG. 11. The three-point hitch mechanism 96 may be a standard mechanism that is transversely fixed relative to the tractor. It may be desirable, however, to fit the tractor with a so-called “row finder” or a three-point hitch guidance mechanism (shown schematically at 300 in FIG. 11) that automatically moves back and forth as the tractor travels over a row to maintain the machine 30 centered over the row 34. Such guidance mechanisms are known in the art. They typically guide a mechanism include a frame fixed to the tractor's three-point hitch and a plate that is movable transversely relative to the frame under the power of a hydraulic cylinder. The rear of the plate bears a three-point hitch arrangement. The mechanism comes with a row follower or other sensor that tracks the row 37 over which the tractor is traveling and provides feedback for automatically moving the plate transversely to the tractor to keep the three-point hitch mechanism centered over the row 37. The row 37 can be sensed using a ground contact mechanism such as a wheel or an optical system that uses pattern recognition or contrast to differentiate the row 37 from the adjacent soil. One such three-point hitch guidance mechanism is manufactured under the trade name Navigator® manufactured by Automatic Manufacturing Company of Pender, Nebr. Another acceptable mechanism is commercially available from Einback under the trade name Row-Guard®. Another mechanism is described in U.S. Pat. No. 4,616,712 to Jorgensen, the entirety of which is hereby incorporated by reference.

The tractor's hydraulic system also is coupled to the hydraulic cylinder and the control valve assembly at this time via hoses 120.

The machine 30 is then towed to the worksite into alignment with the end of a windrow 37 of harvested produce items 36. The hillers 176A and 176B, idler wheels 156A and 156B, and closing disks 178A and 178B typically will be raised at this time. The end of the continuous sheet of shading material 32 is then withdrawn from the roll 34 and manually threaded under the first idler roller 150, over the second idler roller 152, over the bowed bar 164, over and around the third idler roller 154, and under the idler wheels 156A and 156B. The hillers 176A and 176B, idler wheel 156A and 156B, and closing disks 178A and 178B can then be lowered into contact with the ground, readying the machine 30 for use. The tractor then tows the machine 30 over the windrowed row 37 of harvested produce items 36. The hydraulic motor 58 is driven to unwind the shading material 32 from the roll 34 at a linear speed that is at or even slightly greater than the traveling speed of the machine 30, thus playing out the shading material rather loosely. This traveling speed may be on the order of 1.5 to 2 miles per hour or even considerably faster. The rotational speed of the motor 58 is determined in part by the sensed inclination angle of the sensing arm 142 in order to compensate for changes in shading material 32 linear velocity that otherwise would occur as the diameter of the roll 34 decreases. As mentioned above, the material 32 is relatively loosely draped over the produce row at a tension of less than 2.0 LPI and preferably less than 1.0 LPI. The loose material maintains a generally semi-circular transverse cross section rather than being stretched against it and conforming to the “lumpy” profile of the produce items, thus reducing the number of contact points with the underlying onions and improving both shading and ventilation.

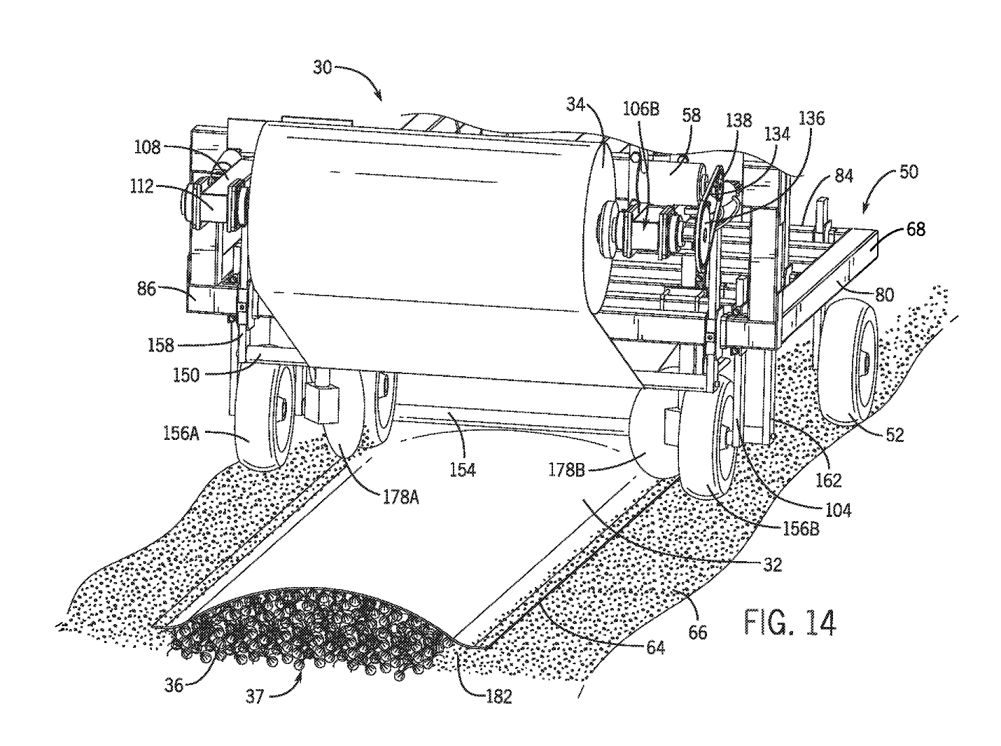

As the machine 30 traverses the row 37, the hillers 176A and 176B dig furrows 182 beside opposed edges of the windrow 37 while piling soil adjacent to furrows 182. As the machine 30 passes over the furrows 182, the shading material 32 is guided over the windrow 37 with its edges overlapping the furrows 182. The idler wheels 156A and 156B then press the thus-laid shading material 32 into the furrows 182, and the edges of the shading material 32 are then covered with soil 66 by operation of the closing disks 178A and 176B. As a result of this operation, the windrowed harvested produce items 36 are securely covered with the shading material 32 as shown in FIG. 14. Because the shading material 32 is only loosely tensioned as it is laid down, it is not stretched into tight contact with the produce items 36, avoiding bruising of the produce items 36 on top of the windrow 37 and improving both shading and ventilation. During this operation, the machine 30 is centered over the row 37 by operation of the three-point hitch guidance mechanism 300. The idler rollers 150, 152, 154 and bowed bar 164 also help prevent the shading material 32 from wandering side-to-side while it is being laid down and inhibit the formation of wrinkles in the shading material 32.

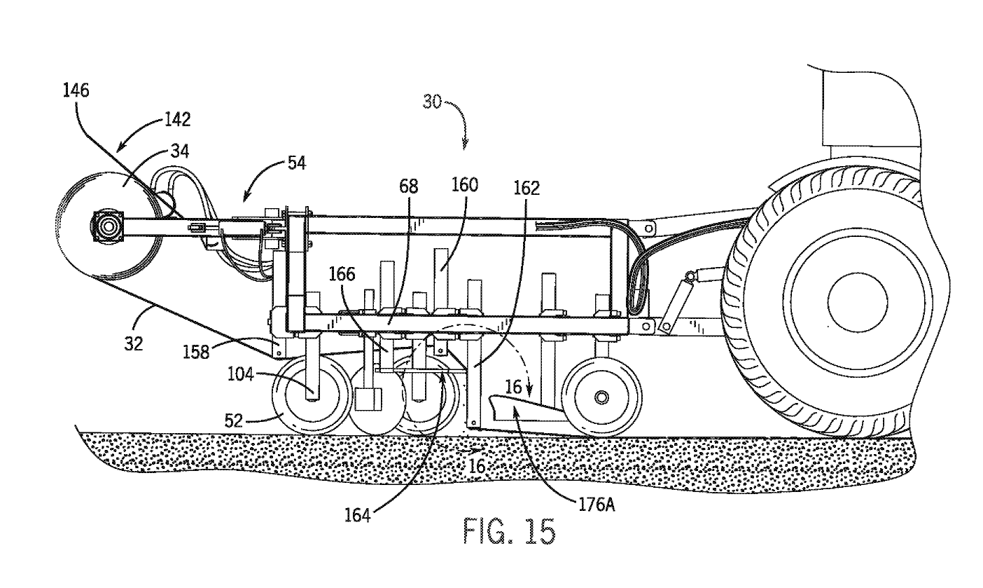

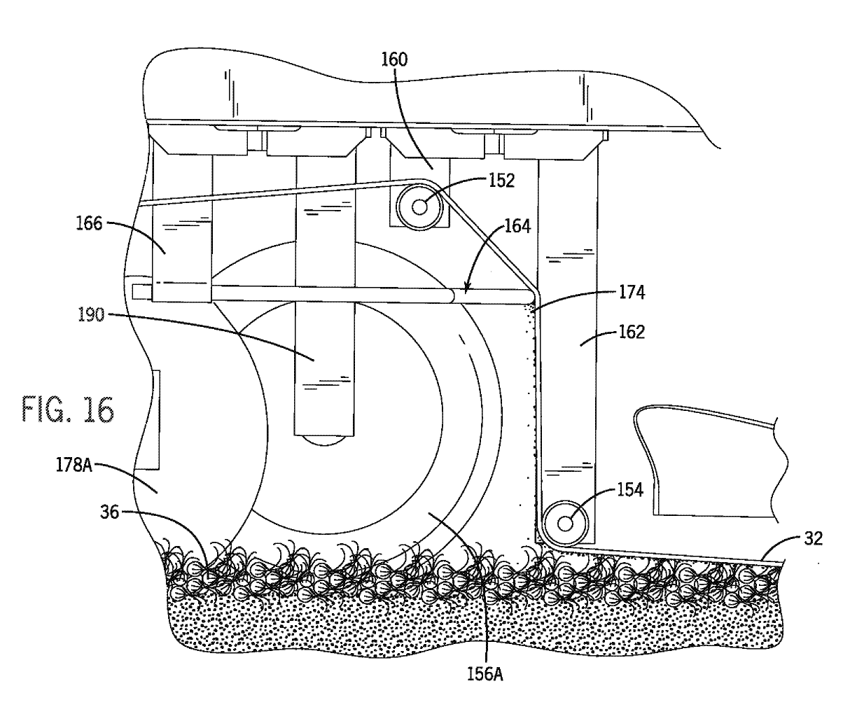

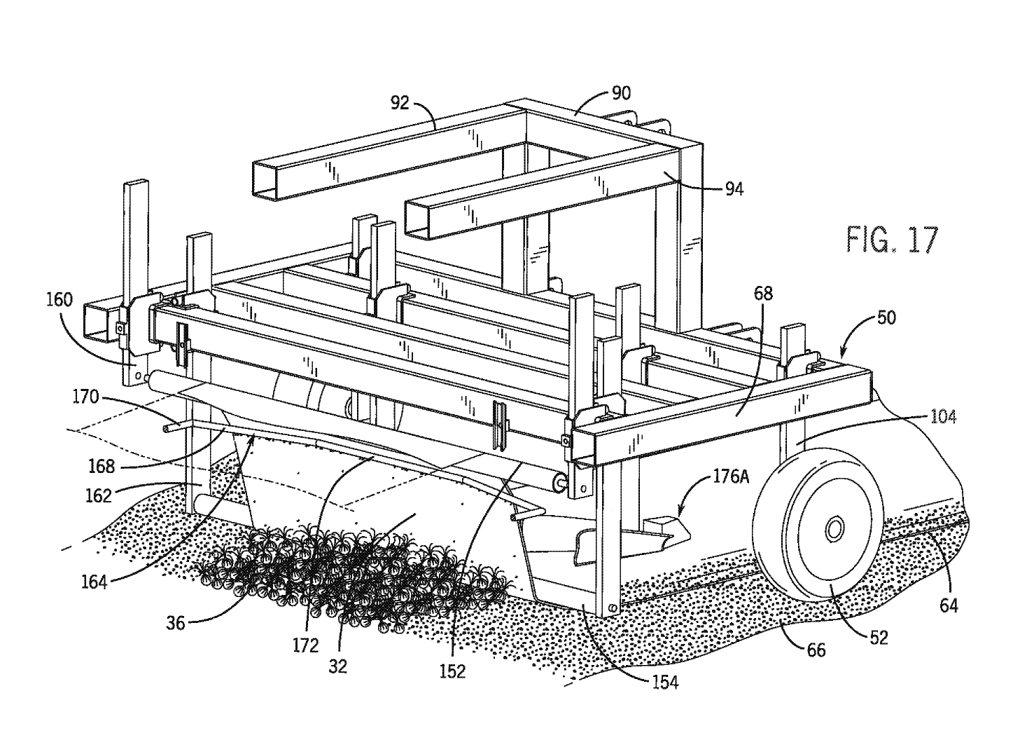

Rewinding the shading material 32 onto a roll 34 for reuse generally involves reversing the procedure for unwinding the material 32 from the roll 34. To prepare the machine 30 for a rewinding operation, an empty roll core 122 is mounted between the core chucks 116, and the hillers 176A and 176B, idler wheels 156A and 156B, and closing disks 178A and 178B are raised out of contact with the ground and clamped in their raised positions. The tractor then tows the machine 30 over the end of a windrow 37 that is covered by the shading material 32. The end of the shading material 32 is then threaded under the third idler roller 154, over the bowed bar 164, over the second idler roller 152, under the first idler roller 150, and onto the roll core 122. The tractor then pulls the machine 30 over the windrow 37 in the direction of the arrow in FIGS. 15-17. The motor 58 is reversed at this time to rewind shading material 32 at a speed that matches the travel speed of the machine 30, taking into account the roll 34 diameter as measured by the sensor arm 142. Motor speed is set relative to machine speed to wind the material 32 onto the roll 34 under sufficient tension to form a compact or tight roll without wrinkles without significantly stretching the material. The material preferably is rewound under a tension in excess of 1.0 LPI and more preferably in excess of 2.0 LPI. As is the case during a lay down or application process, the idler rollers 150, 152, 154 and bowed bar 164 inhibit wrinkling of the shading material 32 by keeping it under light tension. The bowed nature of the bar 164 also inhibits the material 32 from meandering transversely of the machine 30 as the material 32 is rewound. As can be seen in FIG. 16, engagement of the bottom surface of the shading material 32 with the bowed bar 164 helps the material shed debris 174 from its top surface in addition to removing any wrinkles from the material 32.

Although the best mode contemplated by the inventor of carrying out the present invention is disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

We claim:

1. A machine for laying an air permeable shading material on a row of harvested produce items and for subsequently retrieving the material in a manner that permits material reuse, comprising:
a towed frame having front and rear ends;
wheels supporting the frame on the ground;
a roll support, mounted on the frame that supports a roll of a material,
a reversible motor that is mounted on the frame and that imparts a rotational driving force to the roll support; and
guides that guide material being unwound from the roll over the row of harvested produce items as the machine traverses over the row and that guide material being rewound back onto the roll so as to inhibit side-to-side movement of the material relative to the frame and to inhibit material wrinkling.

2. The machine of claim 1, wherein the guides include guide rollers, located under the frame, that direct material between the roll and the row.

3. The machine of claim 1, wherein the guides include a bowed rod that engages material moving therepast so as to inhibit wrinkling of the material.

4. The machine of claim 1, further comprising an edge covering assembly, mounted on the frame, which covers opposed edges of the material with soil after the material is laid down over the row to hold the material in place over the row.

5. The machine of claim 4, wherein the edge covering assembly comprises first and second closing disks, rotatably mounted on the frame and located approximately in-line with opposed edges of the material, that pile soil on the opposed edges of the material to hold the material in place.

6. The machine of claim 5, wherein the edge covering assembly further comprises first and second hillers, each of which is mounted on the frame approximately in-line with one of the opposed edges of the material and which is located longitudinally in front of an associated one of the closing disks, wherein the hillers dig furrows into which the opposed side edges of the material are laid.

7. The machine of claim 6, wherein the edge covering assembly further comprises first and second devices, each of which is mounted on the frame generally in-line with an opposed edge of the strip of material and which is located longitudinally between an associated one of the hillers and an associated one of the closing disks, wherein the first and second devices press the edges of the material into the furrows dug by the hillers.

8. The machine of claim 7, wherein each of the first and second devices comprises one of an idler roller and a ski.

9. The machine of claim 1, further comprising a controller that adjusts an output of the motor to vary depending on the diameter of a roll of material on the roll support.

10. The machine of claim 1, wherein the roll support includes first and second laterally spaced core chucks, at least one of which is driven to rotate by the motor.

11. The machine of claim 1, further comprising a three-point hitch guidance system which is mountable on a prime mover, which tows the frame, which is automatically movable transversely of the prime mover to maintain the frame centered over the row.

12. A method of comprising:
as a mobile frame is towed over a row of harvested produce items, unwinding an air permeable shading material from a roll on a roll support, the roll support being mounted on the frame;
as the frame is directed over the row, laying down the withdrawn material over the row while at least substantially preventing wrinkling of the material or side-to-side motion of the material relative to the frame; and
as the frame is directed over the row, rewinding the material onto the roll while at least substantially preventing wrinkling of the material or side-to-side motion of the material relative to the frame.

13. The method of claim 12, wherein the material an open mesh material.

14. The method of claim 12, wherein the unwinding step includes, using a reversible motor, driving the roll to wind or unwind the material at a linear speed that is no slower than a travel speed of the machine.

15. The method of claim 14, wherein the motor unwinds material roll at a linear rate that is essentially equal to the ground speed of the machine.

16. The method of claim 12, further comprising imposing a tension on the material of less than 2.0 LPI during the laying down operation.

17. The method of claim 16, further comprising imposing a tension on the material of less than 1.0 LPI during the laying down operation.

18. The method of claim 14, further comprising adjusting motor speed in dependence on the prevailing diameter of the roll of material.

19. The method of claim 12, further comprising, while laying down the shading material, covering opposed edges of the material with soil to hold the material in place.

20. The method of claim 19, further comprising, digging furrows into which the edges of the material are pressed prior to covering them with soil.

21. The method of claim 12, further comprising moving the machine transversely over the row as the machine is towed over the row to automatically keep the machine transversely centered over the row.

22. The method of claim 12, wherein the produce items are onions, and wherein the row is a windrow formed by combining several rows of harvested onions together.
